(19) United States
(12) Patent Application Publication
(10) Pub. No.: US 2023/0369750 A1
(43) Pub. Date: Nov. 16, 2023

(54) IN-VEHICLE ANTENNA DEVICE AND IN-VEHICLE COMMUNICATION SYSTEM

(71) Applicant: Yazaki Corporation, Tokyo (JP)

(72) Inventors: Takahiro IWAKI, Shizuoka (JP); Ryohei Nishizaki, Shizuoka (JP); Shingo Suzuki, Shizuoka (JP)

(73) Assignee: Yazaki Corporation, Tokyo (JP)

(21) Appl. No.: 18/141,567

(22) Filed: May 1, 2023

(30) Foreign Application Priority Data
May 16, 2022 (JP) 2022-079961

(51) Int. Cl. H01Q 1/32; H01Q 1/48; H01Q 21/00; H01Q 5/40

(52) U.S. Cl. CPC H01Q 1/3233; H01Q 1/48; H01Q 21/00; H01Q 5/40

(57) ABSTRACT

An in-vehicle antenna device is installed in a vehicle, and includes: an antenna substrate; a plurality of TEL antennas; and a GNSS antenna. In the TEL antenna, an antenna unit is a plate-like antenna which is electrically connected to the antenna substrate via a feeding unit and a GND ground unit. In the TEL antenna, the antenna unit is installed at a position separated by a predetermined length in a first direction that is a direction perpendicular to a substrate plane of the antenna substrate, in such a way as to be parallel to the substrate plane of the antenna substrate. The GNSS antenna is installed on the antenna substrate such that a distance between an upper surface of the GNSS antenna and the antenna substrate is shorter than the predetermined length in the first direction.

### CROSS-REFERENCE TO RELATED APPLICATIONS

The present application is based on, and claims priority from Japanese Patent Application No. 2022-079961, filed on May 16, 2022, the entire contents of which are incorporated herein by reference.

### BACKGROUND OF THE INVENTION

### Technical Field

The present disclosure relates to an in-vehicle antenna device and an in-vehicle communication system.

### Background

A vehicle emergency call system has been proposed in which, when an abnormality occurs in a vehicle, data such as the condition and position information of the vehicle in which the abnormality has occurred is transmitted to a call center to establish voice communication with the call center. An antenna device has been proposed to establish communication with a call center regarding this vehicle emergency call system, and JP 6,461,061 B discloses an antenna device to enable communication with a call center. The antenna device disclosed in JP 6,461,061 B combines a plurality of antennas corresponding to different communication methods for data transmission and reception and voice communication by providing a GNSS antenna on a broadband antenna for telematics.

### SUMMARY OF THE INVENTION

However, when an antenna is installed in a vehicle, the antenna needs to be installed in a limited area of the vehicle, and thus the shape of the antenna device is required to be compact. Meanwhile, as the amount of data handled by an in-vehicle system installed in a vehicle increases, an antenna device installed in a vehicle is required to handle a large amount of data and improve the communication quality for that data. In the antenna device disclosed in JP 6,461,061 B, a GNSS antenna is stacked and disposed on a broadband antenna for telematics. For this reason, the antenna device is required to have a certain size in the up-down direction, and further, the communication quality to the broadband antenna for telematics is affected because the GNSS antenna is disposed thereon. Accordingly, an antenna device has been required that is capable of achieving a shape suitable for installation in a vehicle, and of achieving high communication quality.

The present disclosure has been made in view of such problems with the conventional technology. An object of the present disclosure to provide an in-vehicle antenna device that is suitable for installation in a vehicle, and that is capable of achieving high communication quality.

An in-vehicle antenna device of the present disclosure is installed in a vehicle, and includes: an antenna substrate; a plurality of TEL antennas (telematics) in which an antenna unit is a plate-like antenna which is electrically connected to the antenna substrate via a feeding unit and a GND ground unit, and in which the antenna unit is installed at a position separated by a predetermined length in a first direction that is a direction perpendicular to a substrate plane of the antenna substrate, in such a way as to be parallel to the substrate plane of the antenna substrate; and a GNSS (global navigation satellite system) antenna installed on the antenna substrate such that a distance between an upper surface of the GNSS antenna and the antenna substrate is shorter than the predetermined length in the first direction.

An in-vehicle communication system of the present disclosure includes the in-vehicle antenna device described above, an emergency call speaker, a microphone, and an emergency call switch.

### BRIEF DESCRIPTION OF DRAWINGS

FIG. 1A is a perspective view illustrating a schematic configuration of an in-vehicle antenna device according to the present embodiment.

FIG. 1B is a diagram describing a configuration of the in-vehicle antenna device according to the present embodiment.

FIG. 2 is a block diagram illustrating the configuration of the in-vehicle communication device according to the present embodiment.

FIG. 3A is a plan schematic diagram describing a TEL antenna of the in-vehicle antenna device according to the present embodiment.

FIG. 3B is a schematic diagram describing the TEL antenna of the in-vehicle antenna device according to the present embodiment.

FIG. 3C is a schematic diagram describing the TEL antenna of the in-vehicle antenna device according to the present embodiment.

FIG. 4 is a schematic diagram describing a GNSS antenna of the in-vehicle antenna system according to the present embodiment.

### DETAILED DESCRIPTION OF THE INVENTION

Various embodiments will be described hereinafter with reference to the accompanying drawings.

Hereafter, an in-vehicle antenna system 10 according to the present embodiment will be described in detail with reference to the drawings. Note that the dimensional ratios in the drawings are exaggerated for illustrative purposes and may differ from the actual ratios. In addition, in the following descriptions of the drawings, the same or similar reference numerals are given to the same or similar parts.

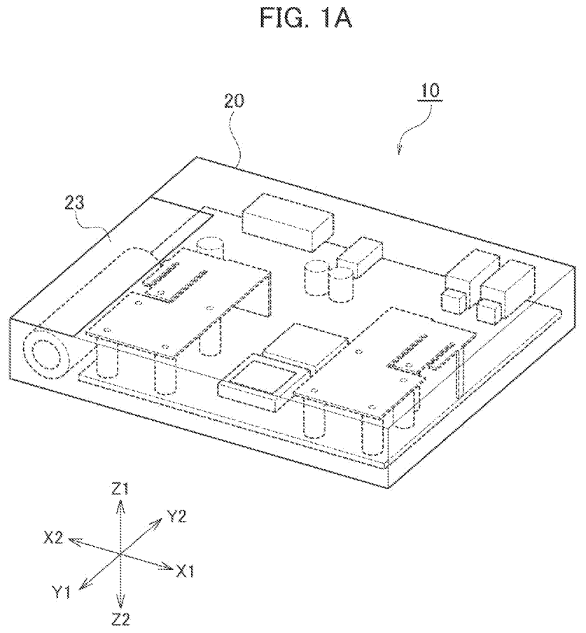

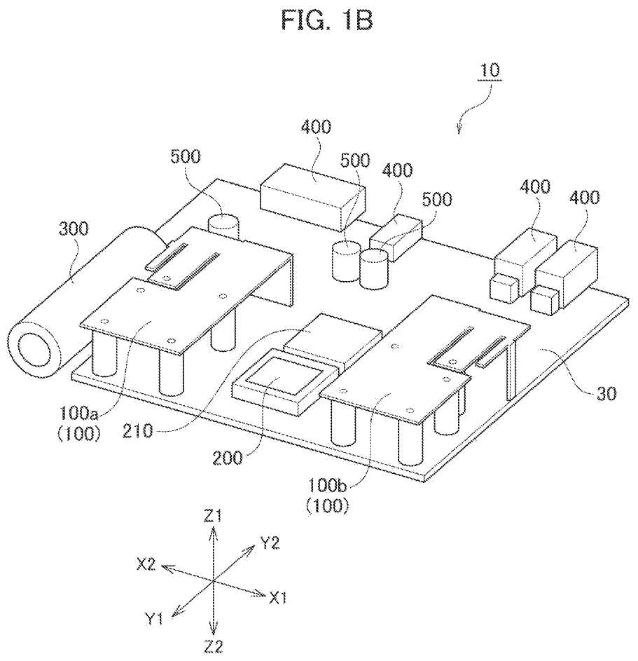

FIG. 1A is a perspective view illustrating the external appearance of the in-vehicle antenna device 10 according to the present embodiment. In the example illustrated in FIG. 1A, the in-vehicle antenna device 10 is covered by a housing 20. The in-vehicle antenna device 10 according to the present embodiment is a device that notifies a call center outside the vehicle of the condition and position information of the vehicle and enables an emergency call to be established with the call center, for example, when an abnormality occurs in the vehicle.

FIG. 1B is a diagram describing the configuration of the in-vehicle antenna device 10 installed inside the housing 20. As illustrated in FIG. 1B, in the in-vehicle antenna device 10, two TEL (telematics) antennas 100a and 100b are installed on the antenna substrate 30. In the in-vehicle antenna device 10, a GNSS antenna 200 (global navigation satellite system) is installed on the antenna substrate 30.

The TEL antennas 100a and 100b are antennas for establishing communication with a call center (network server) that provides emergency call services via a mobile phone communication network. Further, the TEL antennas 100a and 100b are antennas for mobile phone communication such as 4G and 5G (fourth and fifth generation technology standards for broadband cellular networks) to establish voice communication with the call center via a phone line. The in-vehicle antenna device 10 also transmits the position information of a vehicle acquired by the GNSS antenna 200 described later to the call center via the TEL antennas 100a and 100b.

The GNSS antenna 200 is an antenna for receiving signals with time information from a plurality of positioning satellites. The GNSS antenna 200 makes it possible to calculate the position and speed/direction and acquire the time with high precision, thereby making it possible to measure the current position of a vehicle on the ground.

Further, the in-vehicle antenna device 10 includes an amplifier circuit 210, a backup battery 300, connectors 400, and electrolytic capacitors 500.

The amplifier circuit 210 has a function of amplifying a signal received by the GNSS antenna 200.

The backup battery 300 is an auxiliary battery for operating the in-vehicle antenna device 10. For example, even when an abnormality occurs in the vehicle and the power supply from the vehicle to the in-vehicle antenna device 10 is cut off, the backup battery 300 allows the in-vehicle antenna device 10 to continue to operate. The backup battery 300 may be removed or installed independently of the in-vehicle antenna device 10 by individually opening and closing a battery lid 23 of the housing 20 illustrated in FIG. 1A.

The connector 400 is a connector for connecting the in-vehicle antenna device 10 to other units in the vehicle. The other units in the vehicle will be described later. The electrolytic capacitor 500 is a component of the power supply circuit in the in-vehicle antenna device 10.

In the following description, the longitudinal direction of the antenna substrate 30 illustrated in FIGS. 1A and 1B is defined as the X-axis direction, and the short-side direction thereof is defined as the Y-axis direction. Accordingly, the substrate plane of the antenna substrate 30 illustrated in FIGS. 1A and 1B is parallel to the XY plane formed by the X-axis and Y-axis. In addition, the direction perpendicular to the substrate plane of the antenna substrate 30 is defined as the Z-axis direction.

In addition, as illustrated in FIGS. 1A and 1B, the X1 direction indicates the lower right direction in the X-axis direction, and the X2 direction indicates the opposite direction to the X1 direction. In addition, as illustrated in FIGS. 1A and 1B, the Y1 direction indicates the lower left direction in the Y-axis direction, and the Y2 direction indicates the opposite direction to the Y1 direction. Further, the Z1 direction indicates the upward direction with respect to the substrate plane of the antenna substrate 30 in the Z-axis direction, and the Z2 direction indicates the opposite direction to the Z1 direction (the downward direction in the figures). Note that the Z1 direction corresponds to the first direction.

### (Functional Configuration of In-Vehicle Antenna Device 10)

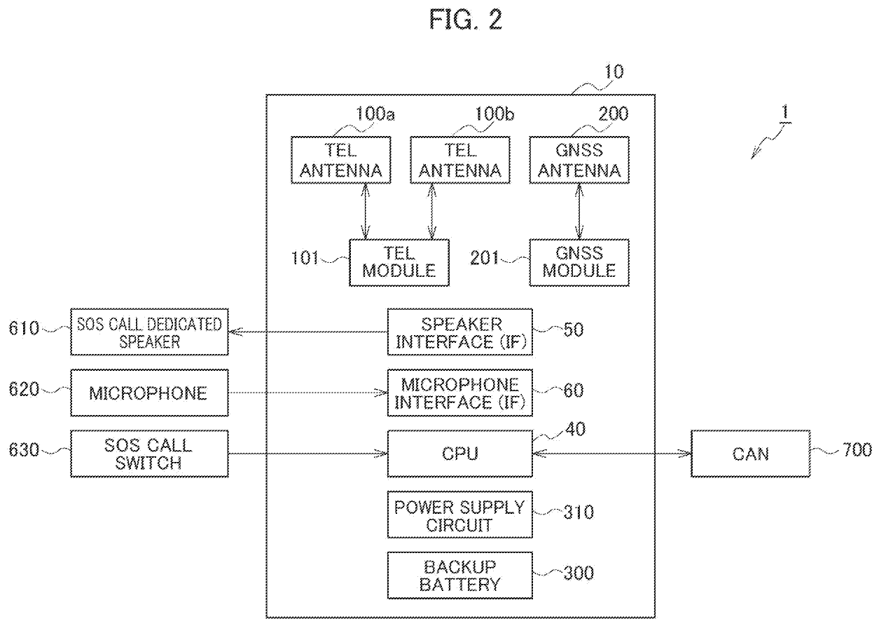

FIG. 2 is a block diagram illustrating the functional configuration of the in-vehicle antenna device 10 according to the present embodiment and the configuration of an in-vehicle communication system 1 provided with the in-vehicle antenna device 10 (vehicle emergency call system). As illustrated in FIG. 2, the in-vehicle antenna device 10 includes a CPU 40, a speaker interface (IF) 50, a microphone interface (IF) 60, a power supply circuit 310, and a backup battery 300. The in-vehicle antenna device 10 further includes the TEL antennas 100a and 100b, the GNSS antenna 200, a TEL module 101, and a GNSS module 201. Hereafter, when it is not necessary to describe each TEL antenna separately, these are simply referred to as the “TEL antenna 100”.

The CPU 40 operates an operating system to control the entire in-vehicle antenna device 10, for example. In addition, the CPU 40 operates to execute each function of the in-vehicle antenna device 10 on the basis of a program stored in a storage unit (not illustrated), for example.

Further, the CPU 40 is connected to an SOS call switch 630 and a CAN 700 (controller area network). For example, when an abnormality occurs in a vehicle, the occupant of the vehicle presses the SOS call switch 630, and the information acquired by pressing the SOS call switch 630 is transmitted to the CPU 40. The CPU 40 having acquired the above information transmitted from the SOS call switch 630 activates a vehicle emergency call function provided in the in-vehicle antenna device 10.

In addition, due to an airbag (not illustrated) or the like being activated when an abnormality occurs in a vehicle, the in-vehicle communication system 1 is activated by transmitting the abnormality information to the in-vehicle antenna device 10 via the CAN 700. The SOS call switch 630 corresponds to an emergency call switch.

The speaker interface (IF) 50 is connected to an SOS call dedicated speaker 610, and outputs, from the SOS call dedicated speaker 610, the speech or the like that is received from the call center via the TEL antenna 100. The SOS call dedicated speaker 610 corresponds to an emergency call speaker.

The microphone interface (IF) 60 is connected to a microphone 620 to acquire the speech spoken by the user, and sends the speech to the call center via the TEL antenna 100.

The power supply circuit 310 controls the power supply system of the in-vehicle antenna device 10, and distributes the power that is supplied from the vehicle to the in-vehicle antenna device 10. When an abnormality occurs in the vehicle, the power supply system is switched to the backup battery 300.

The TEL module 101 and the GNSS module 201 are modules for processing data that are transmitted and received via the TEL antenna 100 and the GNSS antenna 200, respectively.

### (Configuration of TEL Antenna)

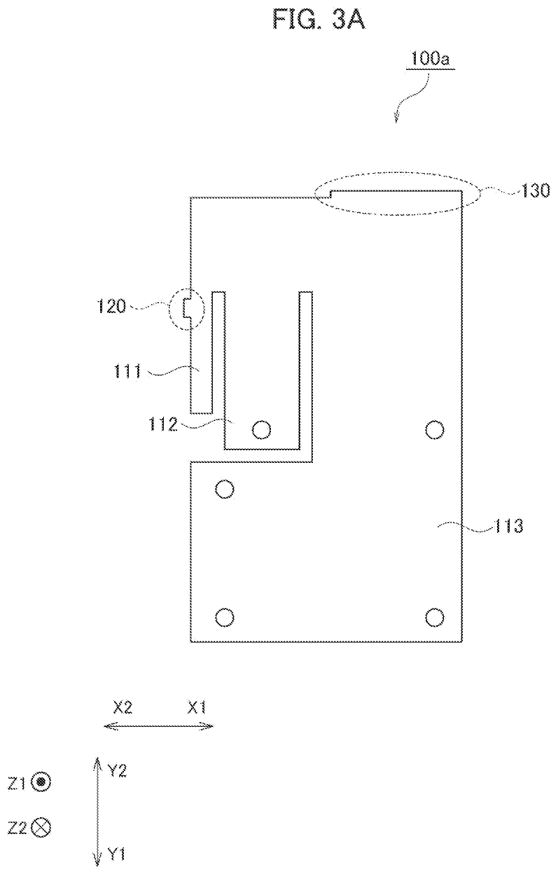

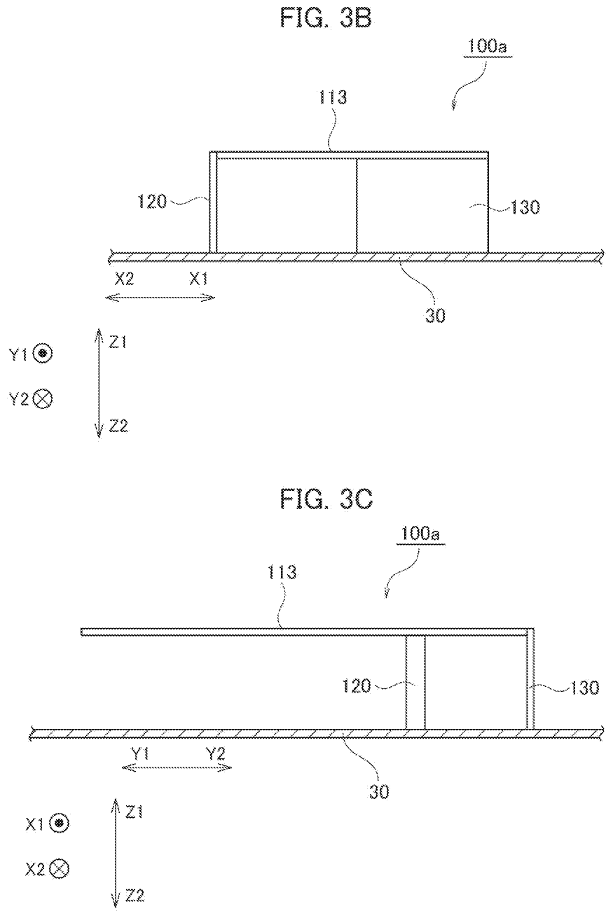

Next, the configuration of the TEL antenna 100 will be described with reference to FIGS. 3A to 3C.

FIG. 3A is a plan schematic diagram of the TEL antenna 100a when viewed from the upper direction of the antenna substrate 30. FIG. 3B is a schematic diagram of the TEL antenna 100a when viewed toward the Y2 direction in FIG. 1B. Further, FIG. 3C is a schematic diagram of the TEL antenna 100a when viewed toward the X2 direction in FIG. 1B.

As illustrated in FIG. 3A, the TEL antenna 100a includes an antenna element 111, an antenna element 112, and an antenna element 113 as an antenna unit. The antenna element 111 is an antenna element for the 3.7 GHz band. The antenna element 112 is an antenna element for the 2 GHz band. The antenna element 113 is an antenna element for the 800 MHz band. Since the antenna unit of the TEL antenna 100 includes a plurality of antenna elements 111, 112, and 113 in this way, the in-vehicle antenna device 10 can communicate with a call center outside the vehicle at a plurality of frequency bands.

The antenna unit of the TEL antenna 100a is a plate-like antenna which is electrically connected to the antenna substrate 30 via a feeding unit 120 and a GND grounding unit 130, as illustrated in FIGS. 3B and 3C.

In addition, as illustrated in FIGS. 3B and 3C, the antenna unit of the TEL antenna 100a is installed at a position separated by a predetermined length in the direction perpendicular to the substrate plane of the antenna substrate 30 in such a way as to be parallel to the substrate plane of the antenna substrate 30. In the present embodiment, the predetermined length indicating the distance between the antenna unit of the TEL antenna 100 and the antenna substrate 30 relates to the transmission and reception efficiency of the vertical polarization of each antenna element of the antenna unit. That is, the predetermined length is determined by optimizing the length on the basis of the relationship between the wavelength of the frequency band corresponding to each antenna element and the peripheral components affecting each antenna element. For example, in the present embodiment, the predetermined length indicating the distance between the antenna unit of the TEL antenna 100 and the antenna substrate 30 is 15 mm.

The configuration of the present embodiment is not limited to the configuration in which the predetermined length indicating the distance between the antenna unit of the TEL antenna 100 and the antenna substrate 30 is 15 mm. The predetermined length indicating the distance between the antenna unit of the TEL antenna 100 and the antenna substrate 30 may be shorter or longer than 15 mm so as to improve the communication quality of the TEL antenna 100. In addition, when the dimensional accuracy of the material used for the TEL antenna 100 is in units of 1/10 mm, the communication quality of the TEL antenna 100 can be improved by performing dimensional control of the predetermined length in units of 1/10 mm according to the target frequency band.

In the present embodiment, the TEL antenna 100b is symmetrical in configuration to the TEL antenna 100a in the X-axis direction. That is, the TEL antenna 100b includes an antenna unit having the same antenna elements 111, 112 and 113 as those of the TEL antenna 100a.

In addition, the TEL antenna 100a and the TEL antenna 100b are installed apart from each other by a predetermined distance in the direction parallel to the substrate plane of the antenna substrate 30. In the present embodiment, the TEL antenna 100a and the TEL antenna 100b are installed apart from each other by a predetermined distance in the X1 direction and X2 direction as illustrated in FIG. 1B. In this respect, the predetermined distance at which the TEL antenna 100a and the TEL antenna 100b are installed apart from each other is such that the TEL antenna 100a and the TEL antenna 100b are not coupled with each other due to radio wave interference.

Since the in-vehicle antenna device 10 includes the plurality of TEL antennas 100 in this way, the in-vehicle antenna device 10 can apply MIMO (multiple-input and multiple-output) to improve the communication quality.

### (Configuration of GNSS Antenna)

Next, the configuration of GNSS antenna 200 will be described.

As illustrated in FIG. 1B, the GNSS antenna 200 is installed on the antenna substrate 30 such that, in the Z1 direction, the distance between the upper surface of the GNSS antenna 200 and the antenna substrate 30 is shorter than the distance between the antenna of the TEL antenna 100 and the antenna substrate 30.

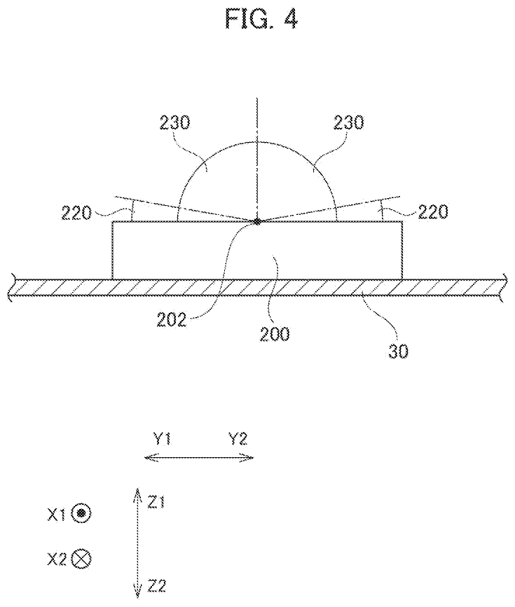

In addition, the in-vehicle antenna device 10 has no specific metal substance (metal shield) that shields communication in a predetermined direction with respect to the GNSS antenna 200 on the antenna substrate 30. Specifically, as illustrated in FIGS. 1B and 4, there is no metal shield at a position on the antenna substrate 30 having a predetermined elevation angle from the feeding point 202 of the GNSS antenna 200 with the feeding point 202 as the center thereof, which is a position in the Y1 direction and Y2 direction.

In the present embodiment, the predetermined elevation angle ranges from 10 degrees to 90 degrees. In the example illustrated FIG. 4, the case where the predetermined elevation angle is 10 degrees is indicated by the angle 220 as an example, and the case where the predetermined elevation angle is 90 degrees is indicated by the angle 230 as an example. That is, the in-vehicle antenna device 10 has no metal shield at a position on the antenna substrate 30 where the predetermined elevation angle ranges from 10 degrees to 90 degrees, which is a position in the Y1 direction and Y2 direction. In the present embodiment, the traveling direction of the vehicle corresponds to the Y1 direction, and the direction opposite to the traveling direction of the vehicle corresponds to the Y2 direction.

That is, in the example illustrated in FIG. 1B, there is no metal shield at a position where the elevation angle of the GNSS antenna 200 in the Y1 direction and Y2 direction ranges from 10 degrees to 90 degrees, and thus the GNSS antenna 200 can establish good communication.

### (Shape of In-Vehicle Antenna Device 10)

As described above, the TEL antenna 100 is installed at a position separated by a predetermined length in the direction perpendicular to the substrate plane of the antenna substrate 30 in such a way as to be parallel to the substrate plane of the antenna substrate 30 in order to ensure the transmission and reception efficiency of the vertical polarization of each antenna element of the antenna unit. In contrast, the GNSS antenna 200 is installed on the antenna substrate 30 such that, in the Z1 direction, the distance between the upper surface of the GNSS antenna 200 and the antenna substrate 30 is shorter than the distance between the antenna of the TEL antenna 100 and the antenna substrate 30. Thus, the in-vehicle antenna device 10 in the present embodiment can be configured in a thin shape that ensures the required minimum length in the direction perpendicular to the substrate plane of the antenna substrate 30. For example, the in-vehicle antenna device 10 installed in the vehicle is configured in a thin shape in this way to be suitable for installation in the vehicle, such as inside the dashboard of the vehicle.

In addition, the backup battery 300 has a cylindrical shape as illustrated in FIG. 1B, and the length (diameter) in the Z1 direction is shorter than the distance between the antenna of the TEL antenna 100 and the antenna substrate 30. In addition, the uppermost part of the backup battery 300 in the Z1 direction is positioned lower in the Z1 direction than the uppermost part of the TEL antenna 100 in the Z1 direction. Thus, even in the configuration in which the backup battery 300 is mounted, the in-vehicle antenna device 10 in the present embodiment can be configured in a thin shape that ensures the required minimum length in the direction perpendicular to the substrate plane of the antenna substrate 30. As described above, the in-vehicle antenna device 10 installed in the vehicle is configured in a thin shape in this way to be suitable for installation in the vehicle, such as inside the dashboard of the vehicle.

As described above, the in-vehicle antenna device 10 is installed in a vehicle, and includes the antenna substrate 30, the plurality of TEL antennas 100, and the GNSS antenna 200. In the TEL antenna 100, an antenna unit is a plate-like antenna which is electrically connected to the antenna substrate 30 via the feeding unit 120 and the GND ground unit 130. Further, in the TEL antenna 100, the antenna unit is installed at a position separated by a predetermined length in the first direction that is the direction perpendicular to the substrate plane of the antenna substrate 30 in such a way as to be parallel to the substrate plane of the antenna substrate 30. The GNSS antenna 200 is installed on the antenna substrate 30 such that the distance between the upper surface of the GNSS antenna 200 and the antenna substrate 30 is shorter than the predetermined length in the first direction.

Thus, the in-vehicle antenna device 10 according to the present embodiment can ensure the transmission and reception efficiency of the vertical polarization of each antenna element provided in the antenna unit of the TEL antenna 100, thereby making it possible to achieve high communication quality. In addition, the in-vehicle antenna device 10 can be configured in a thin shape that ensures the required minimum length in the direction perpendicular to the substrate plane of the antenna substrate 30. For example, the in-vehicle antenna device 10 installed in the vehicle is configured in a thin shape in this way to be suitable for installation in the vehicle, such as inside the dashboard of the vehicle. That is, the in-vehicle antenna device 10 is suitable for installation in the vehicle, and can achieve high communication quality.

In addition, the TEL antenna 100 includes the plurality of antenna elements 111, 112, and 113. Thus, the in-vehicle antenna device 10 can communicate with a call center outside the vehicle at a plurality of frequency bands corresponding to the plurality of antenna elements.

In addition, the plurality of TEL antennas 100 are installed apart from each other by a predetermined distance in the direction parallel to the substrate plane of the antenna substrate 30. As a result, the in-vehicle antenna device 10 can achieve high communication quality using MIMO by installing the plurality of TEL antennas 100 at a distance such that the TEL antennas 100 are not coupled with each other due to radio wave interference.

In addition, the in-vehicle antenna device 10 has no metal shield at a predetermined position in the GNSS antenna 200. The predetermined position is a position on the antenna substrate 30 where the elevation angle from the feed point 202 of the GNSS antenna 200 ranges from 10 degrees to 90 degrees with the feed point 202 as the center thereof, which is a position corresponding to the traveling direction of the vehicle and the direction opposite to the traveling direction thereof. Accordingly, the in-vehicle antenna device 10 has no metal shield at a position where the elevation angle with respect to the GNSS antenna 200 in the Y1 direction and Y2 direction ranges from 10 degrees to 90 degrees, and thus the in-vehicle antenna device 10 can establish good communication with the GNSS antenna 200.

In addition, the in-vehicle antenna device 10 includes the backup battery 300, and the backup battery 300 has a shorter length in the Z1 direction than the distance between the antenna unit of the TEL antenna 100 and the antenna substrate 30. Further, the uppermost part of the backup battery 300 in the Z1 direction may be positioned lower in the Z1 direction than the uppermost part of the TEL antenna 100 in the Z1 direction. Thus, even in the configuration in which the backup battery 300 is mounted, the in-vehicle antenna device 10 can be configured in a thin shape that ensures the required minimum length in the direction perpendicular to the substrate plane of the antenna substrate 30. For this reason, the in-vehicle antenna device 10 installed in the vehicle is configured in a thin shape in this way to be suitable for installation in the vehicle, such as inside the dashboard of the vehicle.

### Other Embodiments

Although the present embodiment has been described in detail with reference to the drawings, the present embodiment is not limited by the contents described in the above description. Moreover, the components described above include those that can be easily assumed by a person skilled in the art and those that are substantially identical. Furthermore, the configurations described above can be combined as appropriate. In addition, various omissions, substitutions or modifications of the configurations can be made to the extent that they do not deviate from the gist of the embodiment.

In the present embodiment, the in-vehicle antenna device 10 has a configuration that includes two TEL antennas 100a and 100b; however, the in-vehicle antenna device 10 is not limited to this configuration. The in-vehicle antenna device 10 may include two or more TEL antennas 100, for example, four TEL antennas 100. This makes it possible for the in-vehicle antenna device 10 to support MIMO or diversity, thereby making it possible to achieve higher communication quality.

The features of the in-vehicle antenna device 10 and the in-vehicle communication system 1 will be described below.

The in-vehicle antenna device 10 according to a first aspect is installed in a vehicle, and includes the antenna substrate 30. In addition, in the in-vehicle antenna device 10, an antenna unit is a plate-like antenna which is electrically connected to the antenna substrate 30 via the feeding unit 120 and the GND ground unit 130. The in-vehicle antenna device 10 includes the plurality of TEL (telematics) antennas 100 such that the antenna unit is installed at a position separated by a predetermined length in the first direction that is the direction perpendicular to the substrate plane of the antenna substrate 30 in such a way as to be parallel to the substrate plane of the antenna substrate 30. The in-vehicle antenna device 10 includes the GNSS antenna 200 (global navigation satellite system) installed on the antenna substrate 30 such that the distance between the upper surface of the GNSS antenna 200 and the antenna substrate 30 is shorter than the predetermined length in the first direction.

According to the above configuration, the in-vehicle antenna device 10 can ensure the transmission and reception efficiency of the vertical polarization of each antenna element provided in the antenna unit of the TEL antenna 100, thereby making it possible to achieve high communication quality. In addition, the in-vehicle antenna device 10 can be configured in a thin shape that ensures the required minimum length in the direction perpendicular to the substrate plane of the antenna substrate 30. For example, the in-vehicle antenna device 10 installed in the vehicle is configured in a thin shape in this way to be suitable for installation in the vehicle, such as inside the dashboard of the vehicle. That is, the in-vehicle antenna device 10 is suitable for installation in the vehicle, and can achieve high communication quality.

The TEL antenna 100 of the in-vehicle antenna device 10 according to a second aspect may include a plurality of antenna elements corresponding to a plurality of frequency bands.

According to the above configuration, the in-vehicle antenna device 10 can communicate with the call center outside the vehicle at a plurality of frequency bands corresponding to a plurality of antenna elements.

The plurality of TEL antennas 100 of the in-vehicle antenna device 10 according to a third aspect may be installed apart by a predetermined distance in the direction parallel to the substrate plane of the antenna substrate 30.

According to the above configuration, the in-vehicle antenna device 10 can achieve high communication quality using MIMO by installing the plurality of TEL antennas 100 at a distance such that the TEL antennas 100 are not coupled with each other due to radio wave interference.

The in-vehicle antenna device 10 according to a fourth aspect need not have a metal shield at a predetermined position on the antenna substrate 30. The predetermined position is a position on the antenna substrate 30 where the elevation angle from the feed point 202 of the GNSS antenna ranges from 10 degrees to 90 degrees with the feed point 202 as the center thereof, which is a position corresponding to the traveling direction of the vehicle and the direction opposite to the traveling direction thereof with respect to the GNSS antenna.

According to the above configuration, the in-vehicle antenna device 10 has no metal shield at a position where the elevation angle with respect to the GNSS antenna 200 in the Y1 direction and Y2 direction ranges from 10 degrees to 90 degrees, and thus the in-vehicle antenna device 10 can establish good communication with the GNSS antenna 200.

The in-vehicle antenna device 10 according to a fifth aspect may further include the backup battery 300. In addition, the backup battery 300 may have a shorter length in the first direction than the predetermined length, and the uppermost part of the backup battery 300 in the first direction may be positioned lower in the first direction than the uppermost part of the TEL antenna 100 in the first direction.

According to the above configuration, even in the configuration in which the backup battery 300 is mounted, the in-vehicle antenna device 10 can be configured in a thin shape that ensures the required minimum length in the direction perpendicular to the substrate plane of the antenna substrate 30. For this reason, the in-vehicle antenna device 10 installed in the vehicle is configured in a thin shape in this way to be suitable for installation in the vehicle, such as inside the dashboard of the vehicle.

The in-vehicle communication system 1 according to a sixth aspect may include the in-vehicle antenna device 10 described in any one of the first to fifth aspects, an emergency call speaker, the microphone 620, and an emergency call switch.

According to the above configuration, the in-vehicle communication system 1 according to the present embodiment can ensure the transmission and reception efficiency of the vertical polarization of each antenna element provided in the antenna of the TEL antenna 100, thereby making it possible to achieve high communication quality. In addition, the in-vehicle antenna system 1 can be configured in a thin shape that ensures the required minimum length in the direction perpendicular to the substrate plane of the antenna substrate 30. For example, the in-vehicle antenna device installed in the vehicle is configured in a thin shape in this way to be suitable for installation in the vehicle, such as inside the dashboard of the vehicle. That is, the in-vehicle antenna system 1 is suitable for installation in the vehicle, and can achieve high communication quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An in-vehicle antenna device which is installed in a vehicle, comprising:
an antenna substrate;
a plurality of TEL (telematics) antennas in which an antenna unit is a plate-like antenna which is electrically connected to the antenna substrate via a feeding unit and a GND ground unit, and in which the antenna unit is installed at a position separated by a predetermined length in a first direction that is a direction perpendicular to a substrate plane of the antenna substrate, in such a way as to be parallel to the substrate plane of the antenna substrate; and
a GNSS (global navigation satellite system) antenna installed on the antenna substrate such that a distance between an upper surface of the GNSS antenna and the antenna substrate is shorter than the predetermined length in the first direction.

2. The in-vehicle antenna device according to claim 1, wherein
the TEL antenna includes a plurality of antenna elements corresponding to a plurality of frequency bands.

3. The in-vehicle antenna device according to claim 1, wherein
the plurality of TEL antennas are installed apart from each other by a predetermined distance in a direction parallel to the substrate plane of the antenna substrate.

4. The in-vehicle antenna device according to claim 1, wherein
there is no metal shield at a position on the antenna substrate where an elevation angle from a feed point of the GNSS antenna ranges from 10 degrees to 90 degrees with the feed point as a center thereof, which is a position corresponding to a traveling direction of the vehicle and a direction opposite to the traveling direction of the vehicle with respect to the GNSS antenna.

5. The in-vehicle antenna device according to claim 1, further comprising a backup battery, wherein
the backup battery has a shorter length in the first direction than the predetermined length, and an uppermost part of the backup battery in the first direction is positioned lower in the first direction than an uppermost part of the TEL antenna in the first direction.

6. An in-vehicle communication system including the in-vehicle antenna device according to claim 1, an emergency call speaker, a microphone, and an emergency call switch.
